(19) United States
(12) Patent Application Publication
(10) Pub. No.: US 2006/0155480 A1
(43) Pub. Date: Jul. 13, 2006

(54) Method for verifying the correct spatial structure of molecules

(76) Inventor: Hans-Robert Kalbitzer, Regensburg (DE)

Correspondence Address: KOHLER SCHMID MOEBUS, RUPPMANNSTRASSE 27, D-70565 STUTTGART, DE

(21) Appl. No.: 11/032,123

(22) Filed: Jan. 11, 2005

(51) Int. Cl. G06F 19/00

(52) U.S. Cl. 702/19; 702/22

(57) ABSTRACT

The current invention concerns a method for quantitative verification of the correct spatial structure of molecules using NMR spectroscopy. Following a comparison between test and reference spectra, a quantitative statement concerning the quality of the sample is made, i.e. the fraction of substance having the correct spatial structure is quantified. The present invention also concerns a computer as well as software for carrying out the method.

This application is related to DE 102 51 373 filed Nov. 5, 2002 the complete disclosure of which is hereby incorporated by reference.

### BACKGROUND OF THE INVENTION

The current invention concerns a method for determining the two or multi-dimensional structure of molecules in accordance with the independent claim.

The structural analysis of molecules with the assistance of multi-dimensional NMR spectroscopy is known in the art. NMR spectroscopy is, in particular, used routinely for determining the chemical (co-valent) structure of small molecules, to verify the assumed structure of natural or synthetic materials, to identify new materials, and to detect intact chemical structures.

A new problem has been raised in the pharmaceutical industry concerning the intact spatial structure (folding) of molecules, in particular macro-molecules such as proteins, since this structure is essential for the pharmacological effectivity of the product. For manufacture of pharmaceuticals, strict quality control is required in order to verify that the medication has a constant, high effectivity and is capable of providing that high effectivity without causing any side effects. As is particular the case for macro-molecules, the effectivity is not only dependent on the intact chemical structure rather also requires maintenance of a particular spatial structure. The verification of the spatial structure of molecules and macro-molecules for the purposes of quality control in industrial production remains an unsolved problem.

The object of the present invention is therefore to present a method with which the correct spatial structure (three dimensional structure) of macro-molecules, in particular for industrial products, can be rapidly and economically determined in a quantitative manner.

### SUMMARY OF THE INVENTION

The solution to this problem is given by a method having the features of the independent claim. In accordance with the invention, one or a plurality of NMR spectra are used to determine whether or not the three dimensional structure of a test molecule agrees with that of a previously defined reference molecule. In order to minimize external influences on the spectrum and the spatial structure, all steps beginning with the preparation of the sample and up to the comparison between the spectra, must be standardized. The standards are defined in a protocol. Execution of the protocol leads to standardized identification of the NMR signals of the molecules.

It is thereby possible, for the first time, to achieve a quantitative statement with regard to the portion of macro-molecules in a sample which have the correct three dimensional structure. The higher this fraction, the larger the probability that the molecule has the desired effects, in particular for pharmaceutical applications. The method in accordance with the invention permits automization of this examination procedure and, for example, can eliminate samples having a fraction of a substance having a correct three dimensional structure which fails to exceed a predetermined threshold value. Since an NMR spectra is directly correlated with the structure of a measured sample, the method in accordance with the invention permits examination of the quality of the example with regard to differences in the structure within regions of the molecule which are absolutely essential for the desired application or, alternatively, in other non-critical regions. In this first case, the sample must be excluded, in the second case the sample is retained.

Advantageous improvements are given in the dependent claims. It is possible to effect NMR measurements with all types of measurement systems (measurement methods) which can register structure information, which enable retrieval of that information, and which are sufficiently sensitive to changes in the structure. Since the chemical shift is very sensitive to changes in the structure, measurement systems are also suitable which reflect chemical shifts of individual atoms or groups with high resolution.

The test spectrum or test spectra can either be compared to an individual single original reference spectrum or to a set of original reference spectra which have been obtained from one or a plurality of samples of test substances in the desired state (reference substance). The comparison to the original data set can then be made. Alternatively, the test spectrum or test spectra can be compared to spectra synthesized from the original spectra or to data sets. In the latter case, optimal results can be achieved when a complete description of all spin systems and the associated three dimensional structure is obtained. In this case, the spectra can be back-calculated with high precision. Synthesized reference spectra are always required when the test spectra are obtained under conditions which are not identical to those of the reference spectrum. In this case, the differences in the measuring conditions can be compensated for during back calculation from the spectra. In this manner, in particular, a NOESY type spectrum can be perfectly simulated with the complete relaxation-matrix-formalism (compare Adrian Görler et. al., “Relax, a Flexible Program for the Back Calculation of NOESY Spectra Based on the Complete Relaxation-Matrix-Formalism”, Journal of Magnetic Resonance 124, 177 to 188 (1997); Adrian Görler et. al. “Computer Assisted Assignment of ¹³C or ¹⁵N edited 3D-NOESY-HSQC-Spectra Using Back Calculated and Experimental Spectra”, Journal of Magnetic Resonance 137, 39-45 (1999)). Another type of spectrum which can be well simulated and therefore is particularly well suited for back calculation is one which is sensitive to the residual dipole coupling in partially oriented samples.

Spectra from molecules which are to be investigated can be recorded in dependence upon that structure and including details of certain chemical structures as well as possible separation of homo-nuclei or hetero-nuclei spectra, i.e. spectra in which nuclei other than ¹H are also detected. The hetero-nuclei spectra can be recorded using substances which have the desired isotopes in natural abundance or from those which have been artificially enriched. It is also useful to select or differentiate possible artifacts in the spectra prior to carrying out the actual comparison of the spectra and/or to compensate for differences in the signal-to-noise ratio between the reference spectrum and the test spectrum in a quantitative manner for carrying out the comparison. Signals, artifacts and noise recognition can preferentially be carried out in an automized fashion, e.g. using a Bayesian analysis, so that only the real signal portions are taken into consideration during the comparison (compare Christoph Antz et. al. “A General Bayesian Method for an Automated Signal Class Recognition in 2D NMR Spectra Combined with a Multi Variant Descriminant Analysis”, J. Biomol, NMR 5, 287-296 (1995); Anja Carina Schulte et. al. “Use of Global Symmetries in Automatic Signal Class Recognition by a Bayesian Method”, Journal of Magnetic Resonance 129, 165-172 (1997)).

The actual comparison between the spectra is then carried out by comparing individual signals with each other. This can either be carried out directly at the level of the original data itself or can be done with the assistance of parameters which are extracted from experimental NMR data in the frequency or time domain. These parameters would be, for example the signal coordinates (chemical shift), the signal intensity, the signal probability and the coupling pattern. The agreement can, for example, be quantified by means of the calculated R values (compare Wolfram Gronwald et. al. (RFAC, A Program for Automated NMR R Factor Estimation, J. Biomol. NMR 17, 137-151 (2000)).

The identification of the molecule having the required structure can be expressed by a probability normalized to one. The probability assessment can, for example, be made in that the reference spectra is not only recorded using reference substances having the intended structure S rather also reference spectra which, in contrast or in comparison to the intended structure, also have a differing undesirable structure S′, e.g. are partially or fully denatured, or which have a structure deviating from the intended structure, although this difference may not encroach upon the effectivity. By correlation of the R values associated with the various reference spectra which compare the reference substances to the test substances, automized measuring of the test substances can lead to an association of each signal of a particular structure with a quantification of a corresponding fraction thereof. Alternatively, a computer can be used to vary the spatial structure in order to back calculate the spectra for determining the probability that the actual spectra corresponds to intact structures.

The present invention also concerns hard- and software for carrying out the method in accordance with the invention, in particular, an appropriately prepared computer and program software for the computer.

Embodiments of the present invention are described in more detail below.

### DESCRIPTION OF THE PREFERRED EMBODIMENT

All kinds of molecules are suitable for application of the method in accordance with the invention. The method in accordance with the invention is particularly well suited for structural verification of proteins, in particular in the event that these proteins constitute an active ingredient in medication, since, in this case, reliable quality control is required. When the active portions of the molecules are correlated with structure, the effectivity can be derived from quantitative determination of the structural quality. Generally speaking, the molecules should be investigated under the conditions in which they are subsequently used. Therefore, in the usual case, they should not be enriched with isotopes. Such enrichment can be carried out in order, for example, to achieve a required sensitivity.

In the method in accordance with the invention, an automized spectral comparison between the reference spectrum or the reference spectra and a test spectrum is measured in order to determine the extent to which the structure of the test molecule agrees with that of the reference molecule. In order to minimize external influences which could change a spectra in an unacceptable manner, all steps beginning with the preparation of the sample and up to the comparison of the spectra are defined in a protocol. Execution of the protocol therefore leads to standardized identification of the molecule and determination of the fraction which is present with the proper spatial structure. A positive identification is expressed in terms of probabilities with possible error identification through improper assignment of probabilities being defined appropriately.

In the embodiment, the protocol consists essentially of six parts in which associated assignments are carried out. The assignments are, in principle, effected using software in either an automized fashion generated by the software, or in conjunction with user input. The protocol data should not be accessible to a normal editor.

Each portion of protocol contains contributions which can assume different values and which are characterized by key words. In principle, entries in the protocol can only be carried out using tailored software, e.g. via an input mask.

The following protocol portions are presented in the embodiment.

### 1. Sample Production and Preparation for the Recording of the NMR Spectra

In this part of the protocol, the external measurement parameters such as ph-value, measuring temperature, purity of the sample, batch number, the solvent material which is utilized, buffer etc. are defined. The chemical composition of the sample and the co-valent structure of the molecules are verified previously, by way of example, using mass spectrometry or chromatographic procedures. When a reference or a test sample is introduced into the measuring apparatus, the software automatically checks for the maintenance of these boundary conditions or carries out a consistency examination, i.e. the software determines whether the measuring values are consistent with the predetermined boundary conditions or if they contradict same. In the latter case, an error message is issued. The software can also simplify the procedure by automatically extracting certain values. When taking a spectra, e.g. all processing parameters are known and are utilized by the software to generate a protocol for analysis. The software can also register which user has carried out the measurement and for what period of time.

### 2. Recording of the NMR Spectrum

In this stage, predetermined boundary conditions for the individual measurements such as pulse sequence, field strength, measuring parameters etc. are defined and verified or adjusted automatically by the software, for each individual measurement. The measurements should be carried out as precisely and as reproduceably as possible.

### 3. Data Processing

In this part of the protocol, the individual measuring data are processed. For example, parameters such as filtering functions, base line corrections, the data set which is to be transformed, and the size following transformation are all recorded. Such data processing is, e.g. described in Cavanagh et. al. “Protein NMR Spectroscopy, Principles and Practice”, Academic Press 1996; A. H. Hausser and A. R. Kalbitzer, “NMR in Medicine and Biology”, Springer Verlag, 1998.

### 4. Post-Processing

In this part, the data are prepared for comparison. Towards this end the steps include, by way of example, the definition of noise as well as signal and artifact regions which are necessary for signal classification (see above).

### 5. Spectral Comparison and Identification

In this part, the actual algorithms or the program segments for carrying out the spectral comparisons are defined and stored

### 6. Issuance of Protocol and Archiving

In this portion, one defines in which form the software should automatically store the measuring results and the comparison, e.g. on a hard disk or on a CD-ROM and in which form the results should be output, i.e. in the form of text or as a graphical representation.

Subsequently, in the ideal case, a probability prediction should be made as to the concentration of molecules in the sample having the correct structure. This prediction can be formulated in two different ways:
a) With an error probability of <a %, >x % of the molecules have the correct spatial structure.
b) With an error probability of <a %, >y % of the molecules have the correct spatial structure.

Since not all denatured molecules are visible in the NMR spectra (e.g. denatured molecules can aggregate with each other) it is necessary to effect an absolute calibration based on an internal standard. This absolute calibration includes quantification of the intensity of the peaks and should preferably be carried out during measurement of the reference spectrum.

The individual spectral comparisons can, e.g. be carried out using commercial software accessible for pure qualitative structural analysis, e.g. for a simple yes/no identification of the molecule. An example of such software is the so-called “AMIX” software from the company Bruker. A series of spectral comparison methods have already been implemented in AMIX and can be utilized for various applications. One should examine the extent to which these various methods can be utilized individually or in combination and with possible appropriate modifications in order to perform protein identification. Identification may not be possible when the test spectrum differs from the reference spectrum, whereby one should define the actual nature of the differences (peak shifts, missing peaks, too many peaks, deviations in line shape, deviations in intensity, etc.) and where the tolerances lie. The ideal algorithm should therefore be able to deliver a normalized or nominal similarity value and, if required, also be capable of making a yes/no decision. In principle, the two spectra can be exchanged during the calculation so that certain factors, e.g. too many peaks or too little peaks, can be combined.

Three different embodiments, a, b, c, are described below and differ from each other in the following ways. With respect to case a, the resonances of a reference spectra are not assigned. In case b, the resonances in the reference spectra are substantially assigned. In case c, both the resonance structures are assigned as in case b, as well as the three dimensional structure (which for example can be extracted from x-ray structural analyses, NMR structural determinations, or structural predictions). The specific methods which are utilized for association of the resonances in cases b and c are not relevant to the described method. Effective mapping strategies are well-known in the art and have been published (see for example Cavanheh et. al. “Protein NMR Spectroscopy, Principles and Practice”, Academic Press 1996).

In order to generate the reference spectrum or reference spectra, only protocol stages 1 through 4 are relevant. By measuring the molecules under various conditions and in various structural states, a complete library of reference spectra can be generated. Towards this end, the reference spectra itself are initially recorded and are processed in accordance with a defined optimized protocol. Subsequent thereto, each peak in the spectrum is associated with the structural element and stored in digital form. The spectrum itself is composed of different classes of signals: Class C₁ having the signals of molecules with the proper structure, class C₂ having the signals of other desired components in the reference spectra (for example buffers), class C₃ having the signals of molecules in an undesired form, class C₄ having the signals of other substances which are undesirable (impurities), class C₅ having artifact signals (measurement or processing artifacts) and class C₆ containing the noise signals. Class C₇ is the class of the signals of a standard (DSS) which is added to the reference sample in fixed, absolute concentration. This standard serves as a frequency reference and for absolute calibration of the signal intensities. Only the signals in the classes C₁ and C₃ are relevant for evaluation of the quality of the sample. The knowledge and data in classes C₂ and C₄ can be useful, whereas the signals in the classes C₅ and C₆ change from measurement to measurement and can generally be eliminated. A Bayesian analysis is e.g. useful for elimination of signals in classes C₅ and C₆.

Signals in class C₁ and, in the event of proper correlation, in classes C₂ through C₄ can, for the case b, and following elimination of classes C₅ and C₆, be used for direct identification based on their chemical shifts (see for example Wolfram Gronwald et. al. “RFAC, A Program for Automated NMR-R-Factor Estimation”, J. Biomol. NMR 17, 137-151 (2000)). In case c, this can also be determined through back calculation of structural-dependent NMR spectra. For case a, the signals in classes C can primarily be identified through elimination of other signal classes (for example recording of reference spectrum while varying the concentration of the components which produce the signals in the classes C₂ to C₄).

The signals in classes C₁ through C₄ are stored separately. In the event that a variation in the measuring conditions is allowed in subsequent analysis, these signals should also be stored in dependence on those measuring conditions. The signals can either be stored in a direct pixel (voxel) manner or specific features such as position (chemical shift), volume, amplitude, multiple-structure and line width can be extracted and stored. For direct storage, among other things, an iterative segmentation is suitable (Neidig, K.-P. Kalbitzer, N. R. “Improved Representation of 2D NMR Spectra by Local Rescaling, J. Mag. Res. 88, 155-160 (1990); Geyer, M. Neidig, K. P. Kalbitzer, H. R. “Automated. Peak Integration in Multi-dimensional NMR spectra by an Optimized Iterative Segmentation Procedure, J. Mag. Res. B 109, 31-38 (1995)). As an alternative, for case c, all parameters which are important for spectral simulation can be stored and subsequently used to back calculate the spectra.

Together with these data, the detection threshold utilized in the reference spectra (except for the case c) must be determined which, in the simplest case, is given by the global signal to noise ratio.

### Comparison Between the Test Spectra and the Reference Spectra

The test spectra are recorded and processed under the same conditions as the reference spectra. In a subsequent step, the integral of the reference signal is determined e.g. using an automotive iterative segmentation routine (see Geyer, M. Neidig, K. P. & Kalbitzer, H. R. “Automated Peak Integration in Multi-dimensional NMR Spectra by an Optimized Iterative Segmentation Procedure”, J. Mag. Res. B 109, 31-38 (1995)) as is implemented in the program “AURELIA”. With this integral, the signal to noise ratio is determined and all signals are simultaneously normalized. Conventional peak identifications routines (see for example Neidig, P. Bodenmüller, H. and Kalbitzer, H. R. “Computer Aided Evaluation of two-dimensional NMR Spectra of Proteins”, Biochem, Biophys, Res. Com. 125, 1143-1150 (1984)) can be used to search for signals in the test spectra and, together with Bayesian analysis signals, be evaluated as belonging to different signal classes.

The signals Rᵢ (C_{J}) of the various signal classes C₁ through C₄ of the reference spectrum or spectra are iteratively identified in the test spectra. In a first step, signals (peak maxima or peak minima) are searched for at positions in the test spectrum at which signals in the reference spectrum are present. An N-dimensional vector r_{s,i} (where N is equal to the number of dimensions of the NMR spectra) is defined in which one or more test signals S_{Tj} may possibly belong to a given reference signal S_{R,i}. The component r_{S,i}^{K} of the search vector r^{s,i} are defined as
r_{S,i}^{K}=2D^{K}+dᵢ^{K}
with D^{K} being the digital resolution in the Kth dimension and di^{K} is the experimentally determined or estimated uncertainty in the position of the test signal Sᵢ in the Kth dimension. In general, more than one test signal is associated with the reference signal and vice versa. The most probable solution can be found through maximizing the associated probabilities. In the simplest of cases, the most probable solution can be found through permutation of all mutual correlations or, in complicated cases, through suitable conventional search algorithms (e.g. simulated annealing, threshold accepting, genetic algorithms, neuronal networks). These probabilities can be determined in a non-normalized, semi-quantitative fashion (score values), or can be extracted in a statistical manner.

Generally speaking, properties of the reference signals are summarized in a characteristics vector E_{R,i} and the properties of the test signals are represented by a characteristics vector E_{T,j} and these vectors are compared and evaluated. Suitable characteristics are, among other things, a separation between the reference and test signals, the volumes and the signal shapes. The probability distributions p(E_{R,i}) can either be extracted experimentally from test spectra or can be estimated from a suitable model.

### Calculation of Quality Criteria

### a) Relative Fraction of Folded Proteins

The relative fraction of properly folded proteins can be determined through a comparison of the normalized signal intensities of signal classes C. Towards this end, one or a plurality of spectral types are compared to determine the intensities of multiple dimensional signals (cross peaks), if possible, of NMR-detectable nuclei which are associated with the proteins. The probability value sf can, in an analogy to the method used for calculation of NMR factors, can be calculated as follows: (compare Gronwald, W., Kirschhöfer, R. Görler, A., Kremer, W., Ganslmeier, B., Neidig, K.-P. and Kalbitzer, H. R., “RFAC, A Program for Automated NMR R-Factor Estimation, J. Biomol. NMR 17, 137-151 (2000)).

$$SF = \frac{{\sum }_{{iεC}_{1}} {I}_{test , i} \cdot {I}_{ref , i}}{{\sum }_{{iεC}_{1}} {I}_{ref , i}^{2}} \qquad ( 2 )$$

with I_{ref,i} being the volume of signals i of class C₁ of the reference spectra and I_{test,i} are the volumes of the associated signals in the test spectrum. Since individual signals in the reference or test spectra can overlap with signals of classes C₂ to C₆ (which would falsify the signal intensities), sf is optimized iteratively. The standard deviation a of extracted sf is initially calculated as

$$σ = \sqrt{\frac{{\sum }_{i = 1}^{N} {( {A}_{ref , i} - {sfA}_{test , i} )}^{2}}{N - 1}} \qquad ( 3 )$$

and those signals are removed for which
\sqrt{(A_{ref,i}−A_{test,i})²}>3σ (4)
steps 1 to 3 are iteratively repeated until the condition according to equation 3 is satisfied for all signals. The fraction of folded proteins cₚ can be calculated as

$${c}_{P} = {s}_{f} \frac{{I}_{ref , s tan}}{{I}_{test , s tan}} \qquad ( 5 )$$

with I_{ref,stan} and I_{test,stan} being the intensities of the standard signals in the reference and test samples. The error Δcₚ is estimated as
Δcₚ=±t/Nσ (6)
with t(N,p) being the correction value from the t-distribution for the sampling of size N and with p being the predetermined probability.

As a final result, the fraction of folded proteins is determined with the probability p≧cₚ−Δcₚ.

### b) Maximum Fraction of Improperly Folded Proteins

The analysis of the reference spectrum is used to describe a subset of reliable protein signals which have been identified, which can be observed in an undisturbed fashion, and which completely describe the native conformation. For the case a, this can be determined through a Bayesian analysis which only includes protein signals with high probability. Spectra with partially denatured proteins are recorded and the signals identified whose intensities are significantly changed. In cases b and c, the correlation is available and one therefore knows whether or not the signal belongs to the original protein. A deviation ΔAᵢ is calculated for the individual signals of the reference spectra

$$Δ {A}_{i} = \frac{{A}_{ref , i} - {s}_{f} {A}_{test , i}}{\vert {A}_{ref , i} \vert} \qquad ( 7 )$$

the minimal fraction c_{N} of properly folded proteins is then given as
c_{N}=min(ΔAᵢ,ΔAᵢ>0) (8)

I claim:

1. A method for verification of correct spatial structures of molecules using multi-dimensional NMR spectroscopy, with at least one reference spectra being taken from a reference substance and at least one test spectrum being recorded from a test substance which is be examined, with the reference spectrum being compared to the test spectrum, the method comprising the steps of:
a) determining a standardized chemical composition for the reference and test substances and determining standardized measurement parameters for these reference and test spectra;
b) automatically verifying chosen chemical compositions of the reference spectrum;
c) automatically verifying measurement parameters during recording of at least one reference spectrum;
d) automatically evaluating and storing data extracted from the at least one reference spectrum;
e) automatically verifying a chemical composition of the test substance;
f) automatically verifying measurement parameters during recordation of at least one test spectrum;
g) automatically evaluating and storing data extracted from the test spectrum;
h) automatically comparing the test spectrum to the reference spectrum; and
i) automatically determining a fraction of test substance which agrees with the spatial structure of the corresponding reference substance, wherein steps e) through i) are repeated as often as necessary.

2. The method of claim 1, wherein the at least one test spectrum is compared to at least one original reference spectrum.

3. The method of claim 1, wherein the at least one test spectrum is compared to a simulated reference spectrum.

4. The method of claim 1, wherein homo-nuclear spectra are recorded.

5. The method of claim 1, wherein hetero-nuclear spectra are recorded.

6. The method of claim 1, wherein two or more different spectra are recorded.

7. The method of claim 1, wherein, in step h), possible artifacts are selected prior to an actual comparison of the spectra.

8. The method of claim 1, wherein, in step i), a probability statement is utilized to communicate a fraction obtained by results of comparison of the spectra.

9. The method of claim 8, wherein, to determine the probability statement, at least one spectrum of the reference substance is recorded and used as a reference spectrum in steps a) through d), which has an undesired structure and corresponding structures are correlated with corresponding R values.

10. The method of claim 8, wherein, in order to determine the probability statement, at least one simulated reference substance spectrum is utilized as a reference spectrum in steps a) through d), which includes an undesired structure, and corresponding structures are correlated with corresponding R values.

11. A computer, which is programmed to carry out the method according to claim 1.

12. A digital recording media having electronically readable control signals which are adapted to cooperate with a computer in such a fashion that the method according to claim 1 can be carried out.

13. A computer program product for carrying out the method of claim 1 after implementation in a computer.

14. The computer program product of claim 13, which is stored on a storage media, a hard disk, a floppy disk, a CD-ROM, or a storage band.
